(19) United States
(12) Patent Application Publication
(10) Pub. No.: US 2010/0245339 A1
(43) Pub. Date: Sep. 30, 2010

(54) METHOD OF PREVENTING IMAGE STICKING ON A TFT-LCD

(75) Inventor: Han-Lin LIN, Taipei City (TW)

Correspondence Address: RABIN & Berdo, PC, 1101 14TH STREET, NW, SUITE 500, WASHINGTON, DC, 20005, US

(73) Assignee: Associated Industries China, Inc., Taipei City (TW)

(21) Appl. No.: 12/414,008

(22) Filed: Mar. 30, 2009

(51) Int. Cl. G06F 3/038

(52) U.S. Cl. 345/214; 345/92

(57) ABSTRACT

A method of preventing image sticking on a TFT-LCD is provided. The TFT-LCD is connected to the display control board so that signals are communicated therebetween; the display control board has a micro-controller for determining whether a timing of input signals is changed; if it do not change within a setting time period, then the image pixels of the TFT-LCD are changed so as to change shapes of the liquid crystals of the TFT-LCD; by controlling the illumination and movement of the image pixels of the liquid crystals of the TFT-LCD will prevent from image sticking. The method for controlling the movement of the image pixels of the liquid crystals of the TFT-LCD is to cause an image frame to move upwards, downwards, leftwards and rightwards; or to cause the image pixels to scan line; or to cause the image pixels to move by “scan point” scanning.

### FIELD OF THE INVENTION

The present invention relates to a method of preventing image sticking, and particularly to a method of preventing image sticking on Display such as TFT-LCD, PDP, CRT, . . . Displays

### BACKGROUND OF THE INVENTION

TFT-LCDs (thin-film transistor liquid-crystal display) are currently widely used. It uses liquid crystal to control the passage of light. The basic structure of a TFT-LCD panel may be thought of as two glass substrates sandwiching a layer of liquid crystal. The front glass substrate is fitted with a color filter, while the back glass substrate has transistors fabricated on it. When voltage is applied to a transistor, the liquid crystal is bent, allowing light to pass through to form a pixel. A light source is located at the back of the panel and belongs to a backlight unit. The front glass substrate is fitted with a color filter, which gives each pixel its own color. The combination of these pixels in different colors forms the image on the panel.

When voltage is applied to a transistor, the liquid crystal is bent and twist, allowing light to pass through to form a pixel; the liquid crystal angles control the amount of light being rotated.

However, there is an effect called ‘image sticking’ If an static image is left on the screen for a long time—tens of hours—then when the image is changed there may be a inverted shadow of the original image left.

This is due to the nature of the technologies “twisting crystals.”

For example, when the Display is used as a Surveillance Security system, it is very easy that the “image sticking” generates by Video splitter split line.

Moreover, when the Display is used in Air Traffic control center's radar system, the image sticking will generate in fix light points by radar system, The Image Sticking will influence the correct determination.

In U.S. Pat. No. 7,411,605, disclosed is an apparatus for preventing image sticking of a video display appliance and method thereof that can effectively remove a black display region appearing on a border part of a display screen of the video display appliance when an image sticking function is performed. The apparatus includes a control unit for outputting a control signal for zooming an input video signal at a predetermined zooming rate and performing the image-sticking prevention function if an image-sticking prevention mode is set, and a video processing unit for zooming the video signal at the predetermined zooming rate and processing the zoomed video signal to display the zoomed video signal on a display screen according to the control signal from the control unit. By zooming the video signal at the predetermined zooming rate and then by repeatedly performing a slight movement of the zoomed video signal being displayed on the display screen left/right/upward/downward, the black display region can be removed from the display screen.

In the former case, the video signal is zoomed and then the zoomed video signal is made to move a little bit on the display screen right, left, up, and down. Although the black display region may be removed from the fringe of display, owing to the operation of zooming, the image in the display screen deforms, which makes the viewer unwell and must be improved.

### SUMMARY OF THE INVENTION

Accordingly, the primary object of the present invention is to provide a method of “preventing image sticking ” on a TFT-LCD. When the Display control board micro-controller to detect whether a timing of input signals is changed; if it does not change within a setting time period, then Display control board micro-controller set controller to start move the Display Data position or change dark and light of image pixels; These method is to change the voltage between electrodes that liquid crystal in image pixel relatively to change the bent and twist angle of the TFT-LCD panel liquid crystal; these changes will prevent display image sticking. The bent and twist angle of the liquid crystal is changed for activation of the liquid crystal.

The method for controlling the movement of the image pixels of the liquid crystals of a TFT-LCD is to make an image frame move to 4 directions; or to make an image line to move by scan line; or to make an image pixels to move by point scanning.

In the manners of protection, most of the display panels may be protected.

Further, in this invention, an OSD (On Screen Display) setting device is provided for settings of display image-sticking prevention in three modes:

mode 1 in which the manners of protection of scanning “surface”, “line”, and “point” that move in 4 directions are provided;

mode 2 in which the manners of protection of scanning “line” and “point” are provided; and

mode 3 in which the manner of protection of scanning “point” is provided.

The program loops for displacement per 8 hours by default. When the input signal is not changed, the image-sticking prevention works in a mode selected on the OSD setting device. When mode 1 is selected on the OSD setting device, the steps of scanning surface, scanning line, and scanning point work sequentially for the means of protection. When mode 2 is selected on the OSD setting device, the steps of scanning line and scanning point work sequentially for the means of image-sticking prevention. When mode 3 is selected on the OSD setting device, the step of scanning point works sequentially for the means of image-sticking prevention.

The various objects and advantages of the present invention will be more readily understood from the following detailed description when read in conjunction with the appended drawing.

### BRIEF DESCRIPTION OF THE DRAWINGS

FIG. 1 shows the structure of the present invention;

FIG. 2 is a flow chart of the present invention;

FIG. 3 is a flow chart of a method A of the present invention;

FIG. 4 is a flow chart of a method B of the present invention;

FIG. 5 is a flow chart of a method C of the present invention;

FIG. 6 is a schematic view illustrating a frame according to this invention that moves from A to E, in which A indicates Shift Right, B indicates Shift Left, C indicates Shift Up, D indicates Shift Down, and E indicates the home position; the blue line is Display Board Frame;

FIG. 7 is a schematic view illustrating a horizontal scan line according to this invention that moves from A to E, in which A indicates a black scanning line, B indicates a white scanning line, and C indicates scanning directions, From up to Down Scan, Scanning every Horizontal scan line alternate black and white (over the same line);

FIG. 8 is a schematic view illustrating a vertical scan line according to this invention that moves from A to E, in which A indicates the black scanning line, B indicates the white scanning line, and C indicates scanning directions, From left to right Scan, Scanning every Vertical scan line alternate black and white (over the same line); and

FIG. 9 is a schematic view illustrating a scan point according to this invention that moves from left to right, scanning every scan point (Pixel) alternate black and white (over the same point pixel), from the first line until the last line, for protection of “point” on the display when each pixel on the display passes through white and black.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

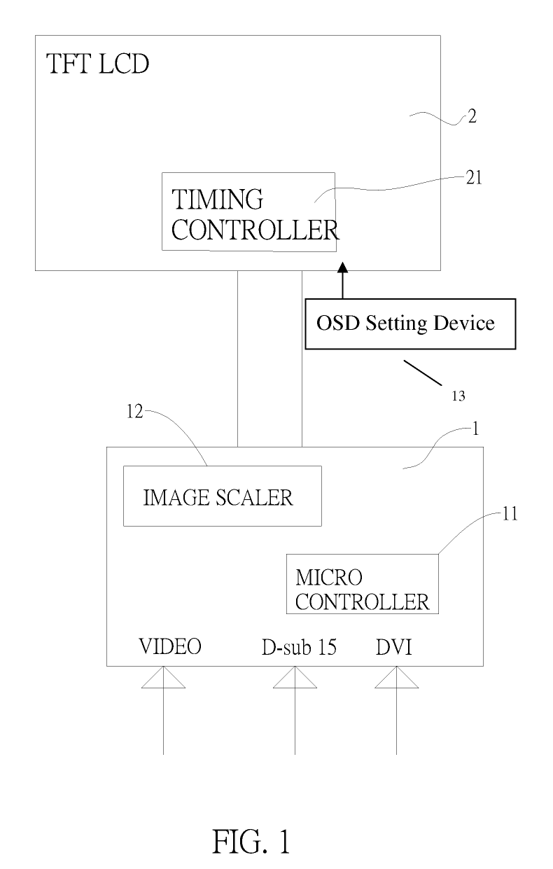

Referring to FIG. 1, the present invention relates to a method of preventing image sticking on a TFT-LCD or other type of Display monitor.

A display control board 1 has an image scaler 12 and is connected to a TFT-LCD 2 so that signals are communicated there between.

The TFT-LCD 2 has a timing controller 21 for receiving LVDS signals from display control board and then converting the signals into RSDS, PPSD, mini-LVDS etc. to drive a source driver and a gate driver, and has a function of gamma calibration.

The display control board 1 has a micro-controller 11 for detecting and determining whether a timing of an input signal is changed. If it is unchanged until a setting time, for example 8 hours later, then the image pixels on the TFT-LCD 2 are changed so that the liquid crystals of the TFT-LCD 2 changes. The function, Image Sticking Protect, is enabled to protect the TFT-LCD from Image Sticking.

By the illumination and movement of the liquid crystal, the shape of the image pixel will change so as to achieve the object protect the TFT-LCD 2 from generating image sticking.

In the present invention, input signals to the display control board 1 may be a D-sub 15 input signal, a DVI input or a video input signals or display signals from a display control board.

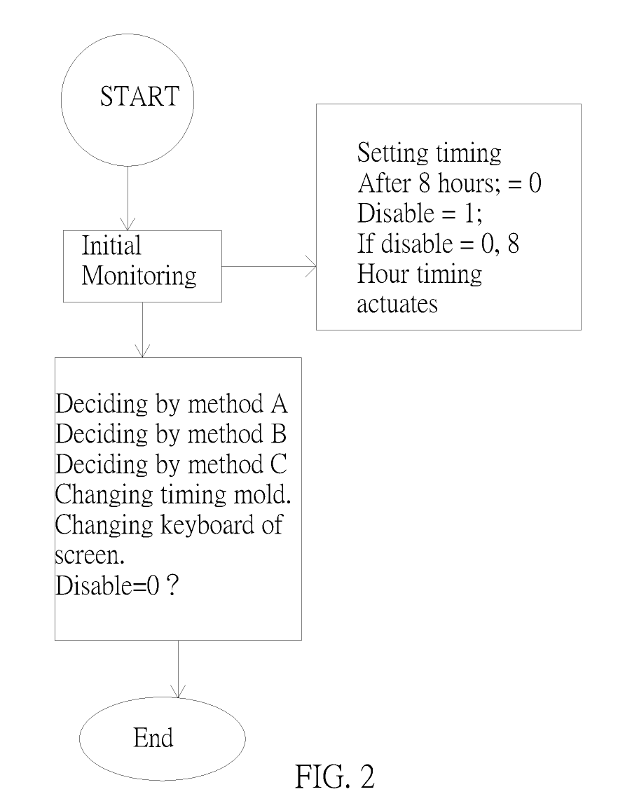

Referring to FIG. 2, the flow diagram about the micro-controller 11 of the display control board 1 according to the present invention is illustrated. After actuating, a monitoring process is performed. A timing is set. After 8 hours of counting time, it is set as 0; while disable is set as 1. If disable is 0, then a counting time of 8 hour is actuated. In this process, it will first determine the movement ways of A, B and C and determines whether the input signal timing is changed, or whether the keyboard is changed, or the disable is equal to zero and then the process is over.

If within a time period of 8 hours, the timing of the input signal is not changed, the image sticking process is actuated, which performs a method selected from the following methods A, B, and C.

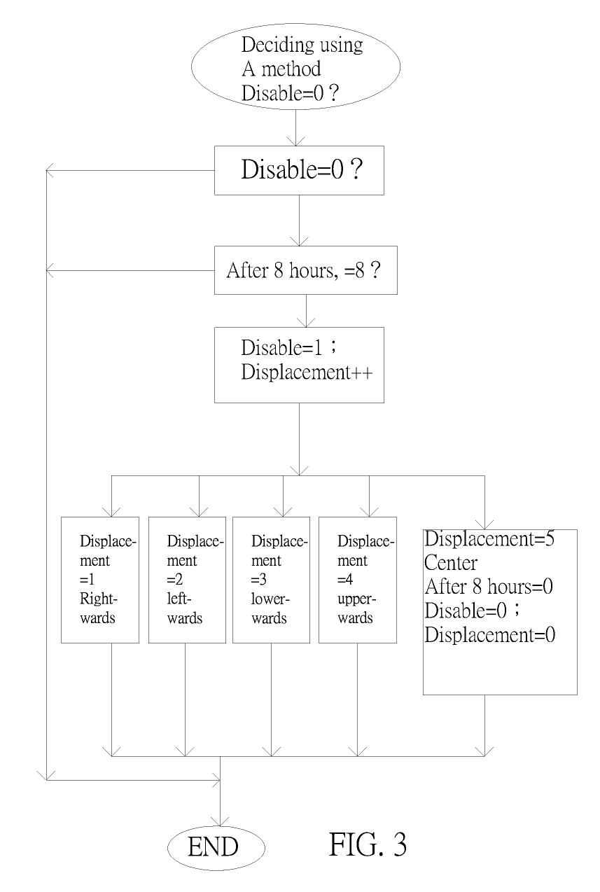

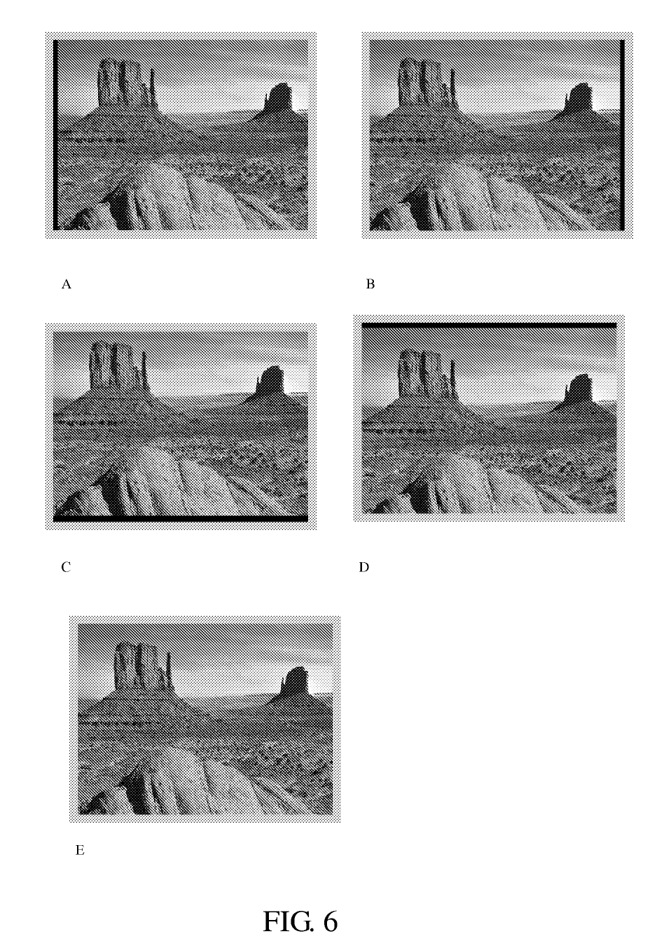

In the method A, a surface image sticking preventing way is used. Referring to FIG. 3, the picture frame of a TFT-LCD moves upwards, downwards, leftwards and rightwards so as to change the data of the frame and activation of liquid crystals so that no image sticking occurs in the liquid crystals. After the movement of the frame, the frame is returned to the center of the frame. Reference of the embodiment in FIG. 6 may also be made.

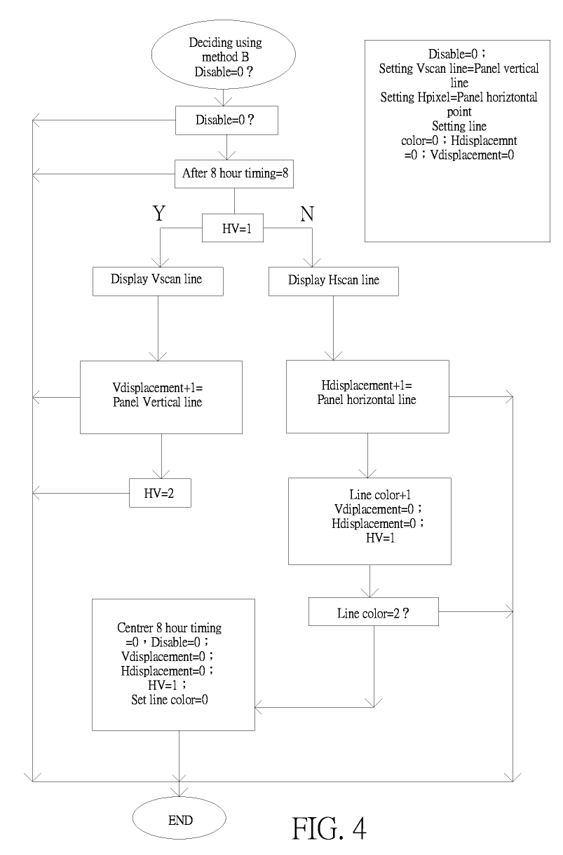

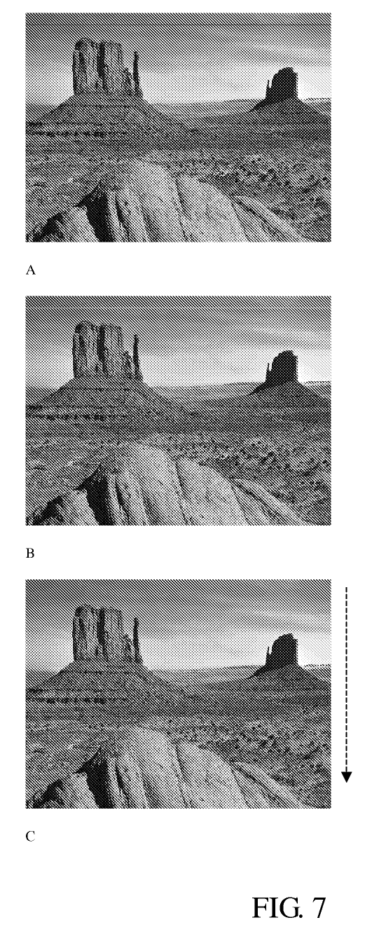

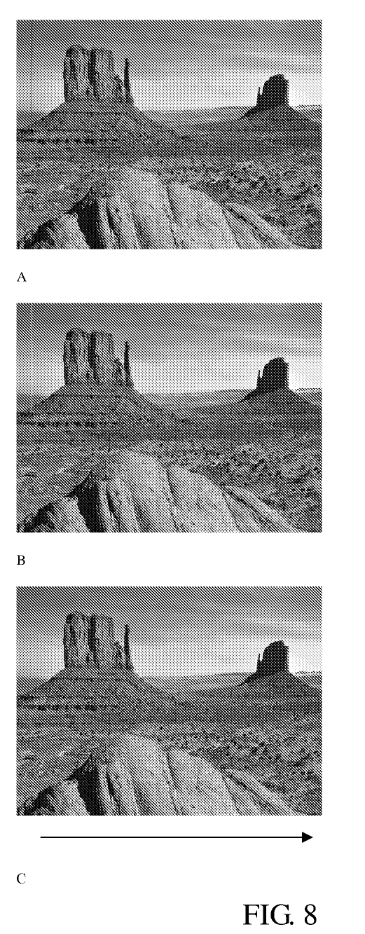

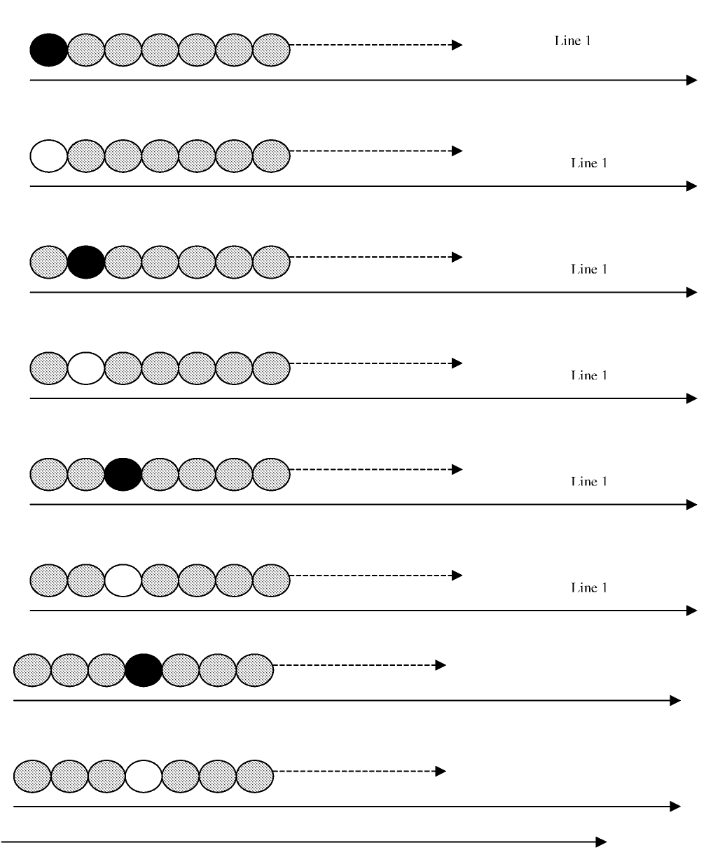

In the method B, a scan line movement is provided, as illustrated in FIG. 4. The scan line movement is divided into horizontal scanning and vertical scanning. The scan is performed from upper side to lower side and from left side to right side through at least 2 times. Moreover, colors and directions of the scanning lines are changeable so as to activate the liquid crystals at different levels. Furthermore, the adjustment is changeable based on the kinds of the liquid crystals (Display Panel Type) so as to have an optimum activation. Reference of the embodiment in FIGS. 7 and 8 may be made.

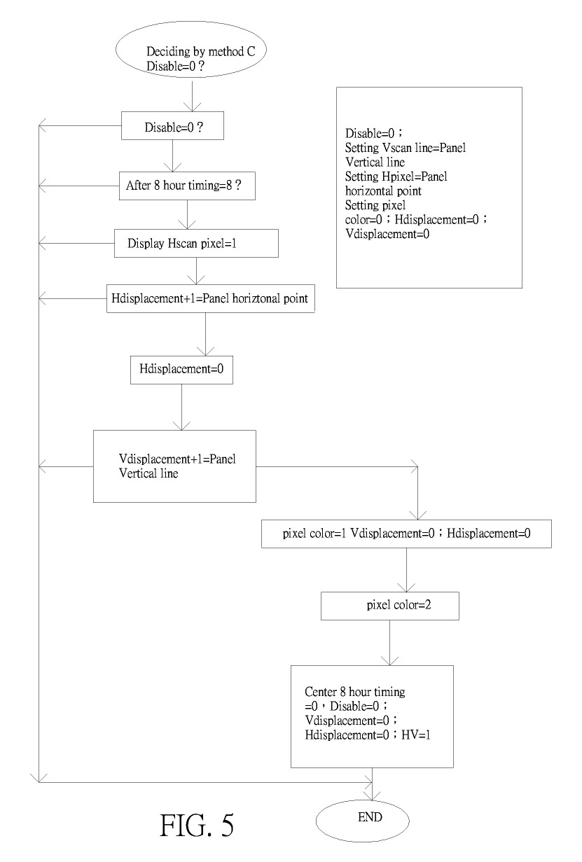

The method C is a point scanning method as shown in FIG. 5. A “scan point” horizontal scanning is performed. When the scan is performed through one line and then the following line scan is performed until all the screen of the TFT-LCD panel is point-scanned to achieve the object of avoiding image sticking. The point scanning for avoiding image sticking is a traceless protection. Furthermore, the color in scanning is adjustable in the method so as to achieve the object of optimum activation. Because the point scanning for avoiding image sticking is difficult to be sensed so that it can be performed for a long time and thus it is an optimum protection way (traceless protection).

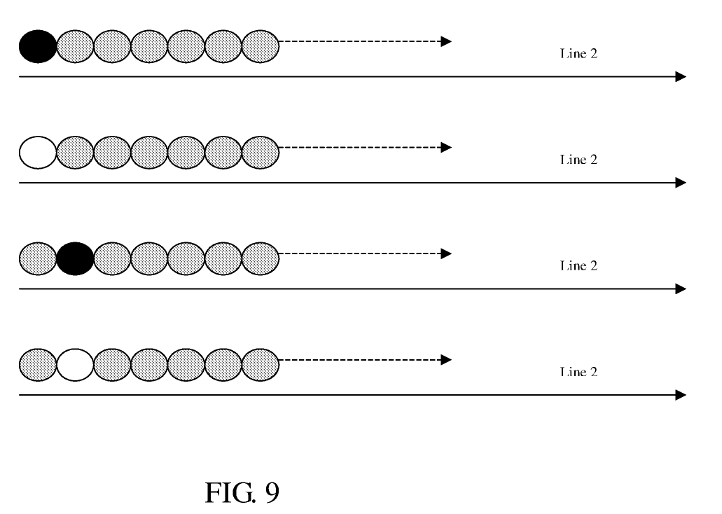

The color of “Scan point” varies to change the angle of LC molecules to the maximum. Reference of the embodiment in FIG. 9 may be made.

Further, with reference to FIG. 1, in this invention, an OSD (On Screen Display) setting device 13 is provided for settings of display image-sticking prevention in three modes:

mode 1 in which the manners of protection of scanning “surface”, “line”, and “point” that move in 4 directions are provided;

mode 2 in which the manners of protection of scanning “line” and “point” are provided; and mode 3 in which the manner of protection of scanning “point” is provided.

The program loops for displacement per 8 hours by default. When the input signal is not changed, the image-sticking prevention works in a mode selected on the OSD setting device. When mode 1 is selected on the OSD setting device, the steps of scanning surface, scanning line, and scanning point work sequentially for the means of protection. When mode 2 is selected on the OSD setting device, the steps of scanning line and scanning point work sequentially for the means of image-sticking prevention. When mode 3 is selected on the OSD setting device, the step of scanning point works sequentially for the means of image-sticking prevention.

From above discussion, it is known that the method of the present invention can achieve the object of avoiding image sticking in the TFT-LCD and therefore the lifetime of the TFT-LCD is prolonged.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method of preventing image sticking on a TFT-LCD; comprising the manners of
connecting a TFT-LCD to the display control board so that signals are communicated therebetween;
using the display control board including a micro-controller to determine whether a timing of input signals is changed, in which if the timing of input signals do not change within a setting time period, then the image pixels of the TFT-LCD is changed and thus the shapes of the liquid crystals of the TFT-LCD are changed; and
TFT-LCDTFT-LCD controlling the illumination and movement of the image pixels of the liquid crystals of the TFT-LCD for prevention of image sticking.

2. The method of preventing image sticking on the TFT-LCD as claimed in claim 1, wherein the input signals are one of D-sub 15 input signals, DVI input signals and video input signals from a computer or other video device.

3. The method of preventing image sticking on the TFT-LCD as claimed in claim 1, wherein the step for controlling the movement of the image pixels of the liquid crystals of the TFT-LCD is to cause an image frame to move upwards, downwards, leftwards and rightwards.

4. The method of preventing image sticking on the TFT-LCD as claimed in claim 1, wherein the step for controlling the movement of the image pixels of the liquid crystals of the TFT-LCD is to cause the image pixels to scan line.

5. The method of preventing image sticking on the TFT-LCD as claimed in claim 1, wherein the step for controlling the movement of the image pixels of the liquid crystals of the TFT-LCD is to cause the image pixels to move by “scan point” scanning.

6. A method of preventing image sticking on a TFT-LCD; comprising the manners of
connecting a TFT-LCD to the display control board so that signals are communicated therebetween;
using the display control board including a micro-controller to determine whether a timing of input signals is changed, in which if the timing of input signals do not change within a setting time period, then the image pixels of the TFT-LCD is changed and thus the shapes of the liquid crystals of the TFT-LCD are changed;
TFT-LCDTFT-LCD controlling the illumination and movement of the image pixels of the liquid crystals of the TFT-LCD for prevention of image sticking; movement of the image pixels inclusively causing an image frame to move upwards, downwards, leftwards, and rightwards, scanning lines, and moving by “scan point” scanning; and
Providing an OSD setting device for settings of display image-sticking prevention in three modes:
Mode 1 in which the manners of protection of scanning “surface”, “line”, and “point” that move in 4 directions are provided;
Mode 2 in which the manners of protection of scanning “line” and “point” are provided; and
Mode 3 in which the manner of protection of scanning “point” is provided;
The program looping for displacement per 8 hours by default; when the input signal is not changed, the image-sticking prevention working in a mode selected on the OSD setting device.
